(19) United States
(12) Patent Application Publication
(10) Pub. No.: US 2016/0267413 A1
(43) Pub. Date: Sep. 15, 2016

(54) ASSIGNING RESOURCE PERMISSIONS

(71) Applicant: HEWLETT PACKARD ENTERPRISE DEVELOPMENT LP, Houston, TX (US)

(72) Inventors: Qianhui Liang, Singapore (SG); Kas Kasravi, West Bloomfield, MI (US); Patrick Goldsack, Bristol (GB); Sau Sheong Chang, Singapore (SG); Christopher Travis Whitney, Singapore (SG)

(21) Appl. No.: 15/032,358

(22) PCT Filed: Oct. 30, 2013
(86) PCT No.: PCT/US2013/067534

§ 371 Date: Apr. 27, 2016

(51) Int. Cl. G06Q 10/06; G06F 21/60

(52) U.S. Cl. CPC G06Q 10/06313; G06F 21/604

(57) ABSTRACT

A technique includes clustering projects that include a new project and previous projects based on relationships between users and the previous projects to identify a project cluster containing the new project. The technique includes clustering the users based on relationships between the users and permissions that were assigned to the users to access resources for previous projects. The technique further includes assigning permissions for the users assigned to the new project to access resources associated with the new project based at least in part on the clustering of users and the clustering of projects.

### BACKGROUND

A business entity may selectively restrict access to its resources by assigning permissions to users. The permissions control the operations that the users may perform on the resources. For example, a given user may be assigned a permission that allows the user to read a particular document (a resource) that is stored on a given server of the business entity, but the user may not be assigned a permission that allows the user to modify the document.

Permissions may be assigned according to an access control model. As examples, the access control model may be a discretionary access control (DAC) model, which may primarily be guided by individual project managers; a mandatory access control (MAC) model, which is a rule-based model; a role-based access control (RBAC) model, which guides the assignments of permissions based on particular job functions or roles; or an attribute based access control (ABAC) model, which guides the assignment of permissions based on attributes of users and resources.

### BRIEF DESCRIPTION OF THE DRAWINGS

FIG. 1 is a schematic diagram of a computer system according to an example implementation.

FIGS. 2 and 3 are flow charts depicting computer-aided techniques to assign permissions to users to access resources in the context of a new project according to example implementations.

FIG. 4 is an illustration of a workflow that uses historical data-based and adaptive machine learning-based techniques to assign permissions to users to access resources in the context of a new project according to an example implementation.

FIG. 5 is an accessibility graph according to an example implementation.

### DETAILED DESCRIPTION

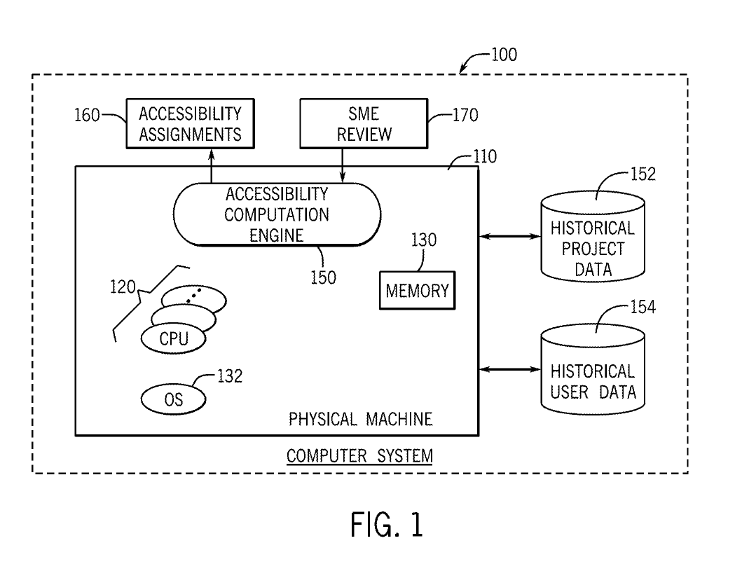

Referring to FIG. 1, in accordance with example implementations that are disclosed herein, a business entity (an enterprise, a business, or a joint venture of businesses, as examples) may use an accessibility computation engine 150 for purposes of selectively assigning permissions to users to access resources of the business entity in the context of a new project. As disclosed herein and in accordance with example implementations, the accessibility computation engine 150 automatically determines permission assignments based on historical data and uses an adaptive selection process that is continually improved based on performance results.

In the following discussion, a “project” refers to one or multiple jobs or tasks, which are collaboratively performed by a given group of users (employees, contractors and/or business affiliates, as examples) for purposes of achieving a given business goal. The “new” project refers to a project for which users have been assigned but for which permissions are yet to be determined. It is noted that some of the users may have collaborated with each other in prior projects.

As examples, a given “resource” may be a digital resource, such as a database, an application, a file, and so forth. “Resources” in the context of this application may also refer to physical resources, such as rooms, printers, machine tools, supplies, chemicals, and so forth.

As examples, a given project may be a set of jobs or tasks to plan, develop and implement a software application; research and publish a magazine article; initiate and develop a marketing initiative; research and develop a business strategy for a targeted market; evaluate employee compensation; and other jobs/tasks in which users collaborate to achieve a wide variety of other business goals. The users that are assigned to the new project may be associated with the same organization or tenant, in accordance with some implementation. However, the users may be associated with different organizations or different tenants, in accordance with further implementations.

As examples of the permissions, in the context of a given project, user A may be assigned a set of permissions that allow user A to read from and write to certain documents stored on server A; limit user A to read only privileges for other documents stored on server A; and prevent user A from accessing certain documents stored on server B.

In accordance with example implementations that are disclosed herein, the accessibility computation engine 150 is constructed to perform such functions as analyzing historical project and user data to assign accessibility controls to users in the context of a new project; applying machine learning to recognize, or learn patterns from past assignments; applying machine learning to the learned patterns to guide the current assignments without relying on manual input (i.e., to remove the “human” element); providing explanations for the assignments for performance analysis; generating a graph showing the current accessibility controls; and receiving feedback through one or multiple feedback loops for continuous, adaptive improvement of the assignment process.

In accordance with example implementations, the accessibility computation engine 150 assigns resource permissions in accordance with a permission model that includes the following four components: the user, the permission, the operation and the resource. The user, also called “u” herein, is defined as an individual user, or person, to be assigned permissions to resources in the context of a project. In accordance with the permission model, a given permission (also called “p” herein) is a tuple, which is defined for an operation (also called “o” herein) on a resource (also called “s” herein), or “p=[o,s].”

Each user of the project team is assigned a set of permissions to the project resources for a period of time for purposes of collaboratively achieving a business goal. A given user may work for multiple projects over a period of time, which may or may not overlap in time.

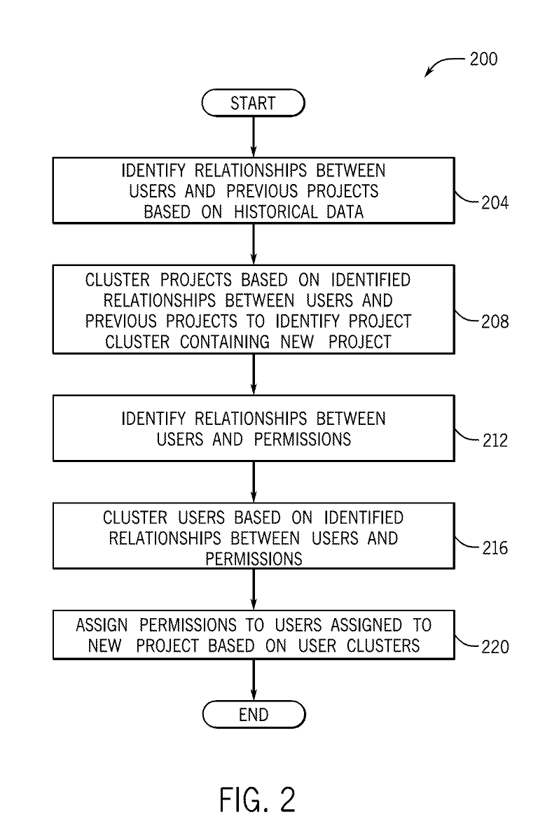

Referring to FIG. 2 in conjunction with FIG. 1, in accordance with example implementations, the accessibility computation engine 150 performs a technique 200 for purposes of assigning resource permissions to users to work on resources in the context of a new project. Pursuant to the technique 200, the accessibility computation engine 150 identifies (block 204) relationships between the users of the project team and previous projects based on “historical data.” In this regard, as further described herein, the “historical data” refers to data representing various attributes of the users, such as dates of hire, salaries, confidentiality levels, skills, educational degrees, nationalities, citizenships, and other such information that may be relevant to the assignments. The “historical data” also refers to the attributes of resources of prior projects associated with the users, such as asset types (e.g., databases, text documents, spreadsheet files) and sensitivity levels (e.g., documents containing personnel data and documents limited to certain managements levels or departments within a business organization, for example). The engine 150 clusters (block 208) the projects based on identified relationships between users and the previous projects associated with the users to identify a project cluster that contains the new project.

The engine 150 identifies (block 212) relationships between the users and the permissions. Pursuant to the technique 200, the engine 150 clusters (block 216) users based on the identified relationships between the users and permissions. Based on the resulting user clusters and the project clusters determined in block 208, the engine 150 assigns permissions to the users to work on resources in the context of the new project, pursuant to block 220. For example, for the new project, the accessibility computation engine 150 assigns a given user the permissions assigned to the users in the corresponding cluster.

Referring back to FIG. 1, in accordance with example implementations, the accessibility computation engine 150 may be part of a physical machine 110. In general, the physical machine 110 is an actual machine that is made of actual hardware and actual machine executable instructions, or “software.” In this manner, the hardware of the physical machine 110 may include one or multiple central processing units (CPUs) 120 and a memory 130. In this regard, the CPU(s) 120 may execute machine executable instructions for purposes of forming the accessibility computation engine 150, an operating system 132, and various other software entities residing on the physical machine 110.

In accordance with example implementations, the physical machine 110 may include such other hardware as a memory 130 that may temporarily store instructions associated with the execution of the machine executable instructions as well as data involved in the preliminary, intermediate and final results associated with this processing.

In general, the memory 130 is a non-transitory storage medium that may be formed from semiconductor storage devices, optical storage devices, magnetic media-based storage devices, removable media devices, and so forth, depending on the particular implementation.

As also depicted in FIG. 1, in accordance with example implementations, the physical machine 110 may receive historical project data from a database 152 and receive historical user data from a database 154. The databases 152 and 154 may be remotely located with respect to the physical machine 110, although the databases 152 and 154 may be part of the physical machine 110 or be otherwise locally coupled to the machine 110, in accordance with further implementations.

Although the physical machine 110 is schematically depicted in FIG. 1 as residing in a box, or cage, the physical machine 110 may be a distributed system that may have its components located at different locations, in accordance with example implementations. Thus, many variations are contemplated, which are within the scope of the appended claims.

As depicted in FIG. 1, the accessibility computation engine 150, in general, provides data indicative of accessibility assignments, as indicated at reference numeral 160. Moreover, as further discussed below, in accordance with some implementations, the accessibility computation engine 150 receives performance review information indicating the performances of past assignments, such as data provided by a subject matter expert (SME) review, as indicated at reference numeral 170, for purposes of adapting the machine learning process used by the engine 150.

In accordance with example implementations, the historical project and user data are formatted into two matrices for use by the engine 150: a user-team frequency matrix and a permission-user frequency matrix. In the user-team frequency matrix, project teams are represented as vectors of length m, where “m” represents the total number of unique users for the project team collection. For a given project team, the ith element of its vector presentation of the project team is the number of permissions that the user i has for this project. It is noted that in accordance with example implementations, the vector for each project team may be relatively sparse, as in general, a relatively small number of users of the entire group of users participate in any one given project team.

If “n” represents the number of teams in the project team collection, then the user-team frequency matrix is an m×n matrix, which represents the collection of project teams. In this matrix, the users are represented by respective rows of the matrix, and the project teams are represented by respective columns of the matrix.

In the permission-user frequency matrix, the users are represented as vectors of length q, where “q” represents the total number of unique permissions in the project team collection. For a given user, the ith element of the vector presentation is the number of times this user is assigned the ith permissions across all of the projects that involve the user.

If “q” represents the number of permissions in the project team collection, then the permission-user frequency matrix is an m×q matrix, which represents the collection of users. In this matrix, the permissions are represented by respective rows, and the users are represented by respective columns.

The problem associated with assigning the permissions may be stated as follows. Given the permission assignments to users in past projects and the set of users who are assigned to work on a new project, the problem to be solved is how to derive the accessibility assignments, or permissions, for the users to work on resources in the context of the new project.

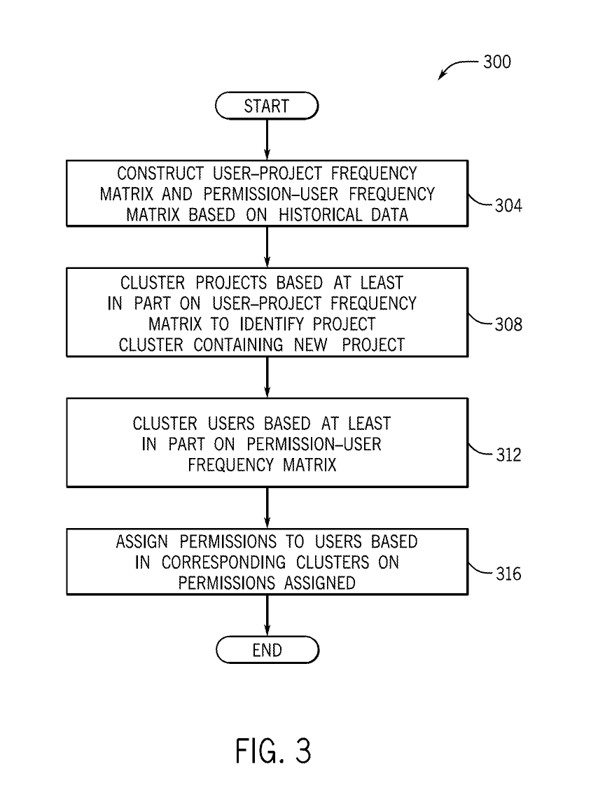

FIG. 3 depicts a more specific technique 300 for purposes of determining the permission assignment using the user-team frequency and permission-user frequency matrices, in accordance with example implementations. Referring to FIG. 3, the technique 300 includes constructing (block 304) the user-project frequency matrix and the permission-user frequency matrix based on historical data, as described above.

In this manner, in accordance with example implementations, machine learning may be applied by examining past assignments, finding correlations and using the correlations to determine rules. Pursuant to the technique 300, patterns in the relationships between the user and project teams are determined, such as a technique that uses Latent Semantic Indexing (LSI), for example.

In other words, matrix factorization of the user-project team frequency matrix may be used to analyze the co-working relationship of users with respect to different types of projects. With the factorization results, high similarity to the same pattern reveals the similarity of the projects, thereby allowing the projects to be clustered. Machine-learning techniques other than rule-based machine-learning (neural network-based learning, for example) may be used, in accordance with further example implementations.

Thus, pursuant to the technique 300, the projects are clustered (block 308) based at least in part on the user-project frequency matrix to identify a project cluster that contains the new project. In other words, in block 308, the projects are clustered based on a rank one approximation of the original user-team frequency matrix, in accordance with example implementations.

Continuing the technique 300, given the project cluster and the projects in this cluster determined in block 308, the technique 300 again applies matrix factorization on the permission-user frequency matrix for purposes of clustering users based on the co-occurrence of permissions. In other words, the technique 300 includes clustering users based at least in part on the permission-user frequency matrix and the resultant clusters of users will be further filtered based on the identified project cluster. Block 312 therefore provides clusters of users.

Finally, pursuant to the technique 300, permissions are assigned (block 316) to the users based on permissions that are assigned in the corresponding clusters. In accordance with example implementations, recommended permission assignments for each user in the new project is determined as the intersection of the sets of permissions that are assigned to the remainder of the users in the same user cluster.

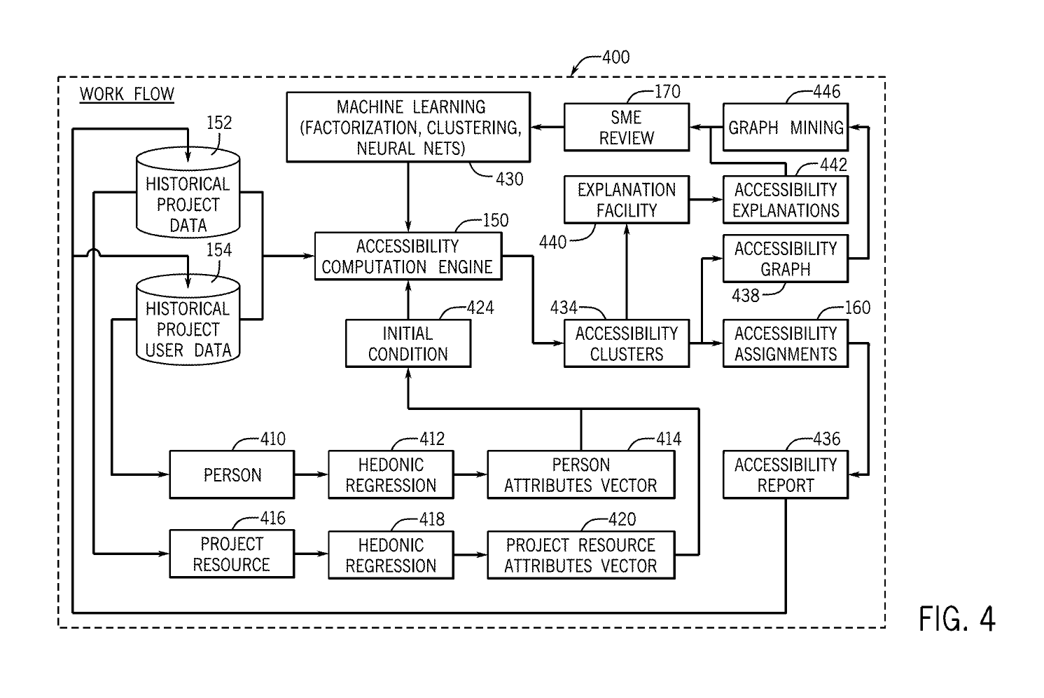

FIG. 4 generally depicts an example workflow 400 used in connection with the determination of permissions in accordance with example implementations. Referring to FIG. 4, the historical project database 152 and the historical project user database 154 store project and personnel data relevant to accessibility analysis, such as, as examples, data pertaining to client confidentiality, document language, hire dates, architectural elements and training experience. This data is used by the accessibility computation engine 150 and machine learning 430 for purposes of determining the permissions. In accordance with example implementations, the data is reformatted into the user-team frequency and permission-user matrices before being provided to the engine 130.

As depicted in FIG. 4, in accordance with example implementations, a hedonic regression 412 may be applied (by the engine 150, for example) to the historical user data 410 for purposes of deriving person attributes vectors 414. Moreover, hedonic regression 418 may also be applied to the project resource data 416 (by the engine 150, for example) for purposes of generating project resource attributes vectors 420. In general, hedonic regression is a technique, which decomposes a relatively complex and relatively ambiguous object into a set of measurable elements.

Thus, the person attributes vectors 414 and the project resource attributes vectors 420 represent the current personnel and project characteristics in quantifiable forms. These vectors 414 and 420, in turn, are provided as an initial condition 424 to the accessibility computation engine 150 and the machine learning 430 applied by the engine 150.

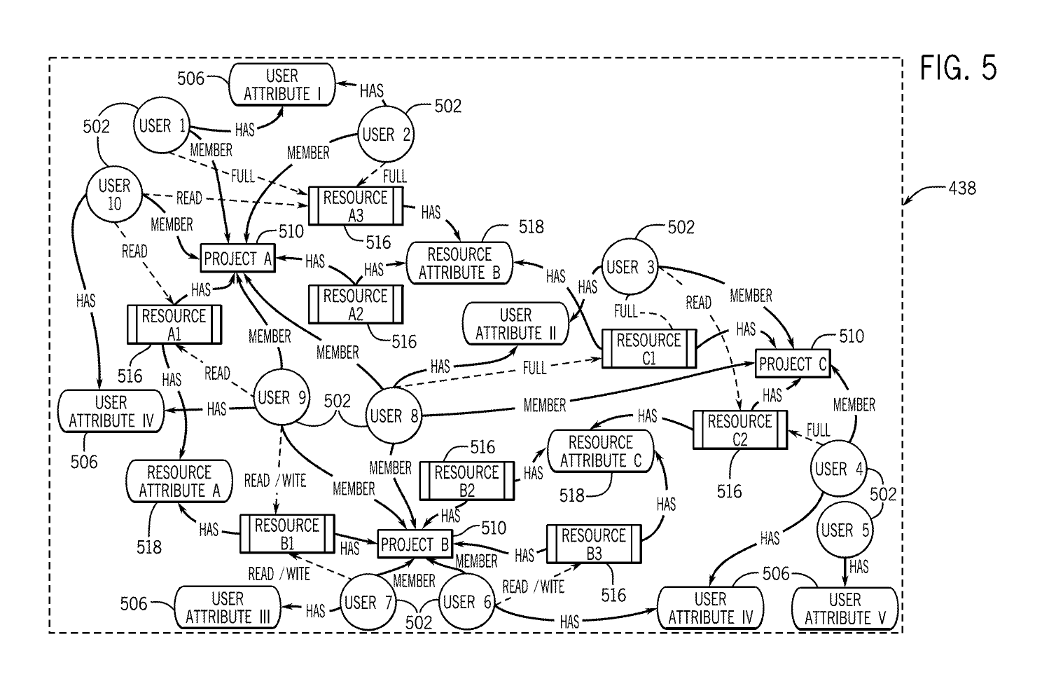

In general, in accordance with example implementations, the accessibility computation engine 150 uses the data from the databases 152 and 154, along with the initial condition 424 and the clustering and pattern recognition capabilities of machine learning 430, for purposes of generating the user clusters, or accessibility clusters 434. The accessibility clusters may be studied using a graph representation in which the nodes of the graph pertain to persons, person attributes, projects, resources and resource attributes; and the edges of the graph pertain to relationships, such as “has,” “member,” and “accessibility value.” An example graph 438 is depicted in FIG. 5.

Referring to FIG. 5, for the graph 438, nodes 502 are associated with the different users that are part of the given cluster; and nodes 506 represents the associated attributes of the users. As depicted in FIG. 5, “has” edges link the user nodes 502 to the user attribute nodes 506. The graph 438 further depicts nodes 510 representing the projects of the user cluster. As shown, “member” edges link the user nodes 502 and project nodes 510, denoting which users are assigned to the different projects.

The graph 438 further has nodes 512 representing the resources. In this manner, permissions are assigned between the users and the resources. As shown in FIG. 5, these permissions are represented by corresponding edges and may be, as examples, a “full” permission denoting full access by a given user to a resource; a “read” permission indicating read access to a given resource by a user; a “read/write” permission indicating read/write access by a given user to a given resource; and so forth. Lastly, the graph 438 contains nodes 518 that represents attributes of the resources and are linked by corresponding “has” edges to the various resources.

Referring back to FIG. 4, in general, the accessibility clusters 434 represent the actual assignments of permissions to project resources by the individuals assigned to one or more projects. These assignments are captured in an accessibility report 436 for use/analysis by project managers, system administrators, security administrators, and so forth, depending on the particular implementation. In general, the accessibility report 436 may be stored in the databases 152 and 154 as historical data for future reference.

The accessibility clusters 434 may be used to form an accessibility graph 438, such as the one depicted in FIG. 5 and described above. In this manner, in accordance with example implementations, a graph mining process 446 may be applied to the accessibility graph 438 for purposes of analysis by graph analysis tools. The result, along with accessibility explanations 442 provided by an explanation facility 440 may then be analyzed by one or more human subject matter experts (SMEs).

In this manner, the graph analysis may include checks on accuracy, accessibility requirements, system utilization and accessibility validation. The explanation facility 440 analyzes the graph and provides the underlying reasoning for each accessibility assignment in the accessibility clusters 434.

For example, if a particular pattern used in connection with the machine learning 430 may be represented as an IF-THEN rule to explain why a person was assigned a certain permission level to a resource. The aggregate of the analysis that is performed by the explanation facility 440 is captured in the accessibility explanations 442 for review by the SME reviews 170.

In accordance with example implementations, the SME review 170 may be performed for purposes of determining whether the outcome of the solution is on target and meets any regulatory or audit requirements, i.e., for purposes of evaluating the performance of the assignments made by the accessibility computation engine 150.

The outcome of the SME review 170 (either positive or negative) is received through the feedback to adapt the machine learning 430 so that the solution reduces the probability of error and increases accuracy in the next iteration. This feedback process, along with the accessibility report 436 being fed back into the historical databases 152 and 154, provides two feedback loops for purposes of adapting and improving the solution over time.

Among the potential advantages of the systems and techniques that are disclosed herein, an enhanced security policy enforcement mechanism is disclosed. Data leak prevention (DLP) is provided. The permission assignment is adaptive such that the adaptive solution may change for changing business needs, where both the workforce and project compositions may change over time. Other and different advantages are contemplated, which are within the scope of the appended claims.

While a limited number of examples have been disclosed herein, those skilled in the art, having the benefit of this disclosure, will appreciate numerous modifications and variations therefrom. It is intended that the appended claims cover all such modifications and variations.

What is claimed is:

1. A method comprising:
clustering a plurality of projects comprising a new project and previous projects based on relationships between a plurality of users and the previous projects to identify a project cluster containing the new project, the plurality of users comprising users assigned to the new project and users assigned to the previous projects;
clustering the plurality users based on relationships between the plurality of users and permissions to access resources assigned to the users for previous projects; and
assigning permissions for the users assigned to the new project to access resources associated with the new project based at least in part on the clustering of users and the clustering of projects.

2. The method of claim 1, wherein clustering the projects based on the relationships between the plurality of users and the previous projects comprises clustering based on a frequency at which the users are assigned permissions to access the project resources in the previous projects.

3. The method of claim 1, wherein clustering the projects based on the relationships between the users and the permissions comprises clustering the users based at least in part on a frequency at which the same permissions are assigned to the users in the previous projects.

4. The method of claim 1, wherein the clustering of projects or the clustering of users comprises using machine learning to determine at least one of the relationships between the users and the previous projects and the relationships between the users and the permissions.

5. The method of claim 4, wherein applying machine learning comprises applying the machine learning based at least in part on characteristics of the users and characteristics of the plurality of projects.

6. The method of claim 5, further comprising:
applying regression to determine at least one of the characteristics of the users and the characteristics of the plurality of projects.

7. The method of claim 5, further comprising adapting the machine learning based at least in part on a manual review of the assignments.

8. An apparatus comprising:
at least one database to store historical data about users assigned to previous projects, resources associated with the previous projects and permissions previously assigned to the users to access the resources associated with the previous projects; and
an accessibility computation engine comprising a processor to:
cluster a plurality of projects comprising a new project and the previous projects based on relationships between a plurality of users and the previous projects to identify a project cluster containing the new project, wherein the plurality of users comprises users assigned to the new project and the users assigned to the previous projects;
cluster the plurality of users based on relationships between the users and the permissions to access resources assigned to the users for the previous projects; and
assign permissions to the users assigned to the new project to access resources associated with the new project based at least in part on the user clusters and the project clusters.

9. The apparatus of claim 8, wherein the accessibility computation engine is adapted to cluster the plurality of projects based at least in part on a frequency at which the users are assigned with permissions to access the resources associated with the previous projects.

10. The apparatus of claim 8, wherein the accessibility computation engine is adapted to cluster the users based at least in part on a frequency at which the same permissions are assigned to the users assigned to the previous projects.

11. The apparatus of claim 8, wherein the accessibility computation engine is adapted to apply machine learning to perform at least one of the clustering of the projects and the clustering of the users.

12. The apparatus of claim 11, wherein the accessibility computation engine is adapted to apply the machine learning further based at least in part on characteristics of the users and characteristics of the projects.

13. An article comprising a non-transitory computer readable storage medium to store instructions that when executed by a computer cause the computer to:
cluster a plurality of projects comprising a new project and previous projects based on relationships between a plurality of users and the previous projects to identify a project cluster containing the new project, wherein the plurality of users comprises users assigned to the new project and users assigned to the previous projects;
cluster the plurality of users based on relationships between the users and the permissions to access resources assigned to the users for the previous projects; and
assign permissions for the users assigned to the new project to access resources associated with the new project based at least in part on the clustering of the plurality of users and the clustering of the projects.

14. The article of claim 13, the storage medium storing instructions that when executed by the computer cause the computer to cluster the projects based at least in part on a frequency at which the users are assigned permissions to access the project resources associated with the previous projects.

15. The apparatus of claim 8, the storage medium storing instructions that when executed by the computer cause the computer to cluster the users based at least in part on a frequency at which the same permissions are assigned to the users in the previous projects.
